(19) United States
(12) Patent Application Publication
(10) Pub. No.: US 2021/0150073 A1
(43) Pub. Date: May 20, 2021

(54) METHOD FOR CHECKING THE INTEGRITY OF A DEDICATED PHYSICAL ENVIRONMENT FOR THE PROTECTION OF DATA

(71) Applicant: PHYSEC GMBH, Bochum (DE)

(72) Inventor: Christian ZENGER, Bochum (DE)

(21) Appl. No.: 16/626,313

(22) PCT Filed: Jun. 21, 2018
(86) PCT No.: PCT/EP2018/066605

§ 371 Date: Dec. 23, 2019

(30) Foreign Application Priority Data
Jun. 23, 2017 (DE) 10 2017 114 010.7

(51) Int. Cl. G06F 21/78; H04L 9/08; G06F 21/62; G06F 21/64

(52) U.S. Cl. CPC G06F 21/78; G06F 21/64; G06F 21/62; H04L 9/0866

(57) ABSTRACT

A method and an apparatus for the protection of data of a computer system against unauthorized activities is provided in which data of the computer system being stored on a storage medium and encrypted with a first cryptographic key and/or integrity-protected can be changed by means of a processor unit of the computer system connected to the storage medium, with both the storage medium and the processor unit being arranged in a physically dedicated environment. This allow for optimal data protection at low cost. Antennas for transmitting and receiving electromagnetic signals are arranged in the physically dedicated environment. The characteristics of the transmission channels between transmitter and receiver which depend on the dedicated physical environment are measured, cryptographic material from which a second cryptographic key is generated is extracted from the measurement results of this measurement, and this key is used for additional encryption and decryption of the data and/or of the first cryptographic key.

### FIELD OF INVENTION

The present invention relates to a method and an apparatus for the protection of data of a computer system against unauthorized activities, in which data of the computer system stored on a storage medium and encrypted and/or integrity-protected (e.g., by HVAC) with a first cryptographic key can be changed using a processor unit of the computer system connected to the storage medium, with both the storage medium and the processor unit being arranged in a physically dedicated environment.

### BACKGROUND INFORMATION

Computer systems contain and process a plurality of sensitive information, for example, personal data, access data, cryptographic material, login data, IP (“Internet Protocol”) data, in-house company internals or security-critical data. In spite of that, such information and data are often inadequately protected against unauthorized activities due to the fact that built-in or retrofittable protection mechanisms are not effective enough, cannot be implemented technically and/or are too expensive. Components of computer systems that are to perform critical functions, such as the storage of or access control to sensitive data, are potential targets of attacks. Examples of computer products, housings, or systems that contain and/or process sensitive data and are particularly worthy of protection (must be tamper-resistant) are: ATMs, statement printers, servers, hardware security modules (HSMs), set-top boxes, communications systems, military systems, computer systems for critical infrastructures (nuclear reactor controls), protection mechanisms of bank vaults, safes or cargo containers. There appear to be numerous proposals for the detection of unauthorized manipulation/tampering attempts, for example, for the detection of boreholes made in a computer system housing. U.S. Pat. No. 5,506,566 appears to make use of one or more layers of conductor paths, which are assigned to the housing wall, lie as close together as possible, have a somewhat random structure and are connected in a resistance bridge or similar. Damage to the wires leads to detuning and thus causes an alarm to be initiated. If, for example, a potting compound is additionally used to embed the strip conductors, this solution is deemed stable in the long term. However, it is technically quite difficult and expensive to produce such an apparatus. Moreover, such a solution can be used to a limited extent only on smaller assemblies due to poor heat dissipation.

Furthermore, to provide switches, seals or stickers/tags on the housing of the computer system has already been suggested. These are however easy to manipulate. To design the entire housing in such a way that preferably any manipulation attempt can be detected, is for manufacturing reasons very complex and therefore extremely expensive.

Optical, electronic, capacitive and acoustic means have also been proposed with a view to detecting manipulation attempts.

Currently, research is also pursuing solutions in which computer systems are protected by the provision of a “signature” unique to such a computer system by radiating material, artificial DNA or randomized particles. These solutions as well are extremely complex in terms of production requirements and, in addition, are not easy to measure; furthermore, their long-term/ageing behavior is unclear.

U.S. Pat. No. 9,389,650 appears to propose checking the presence and intensity of radiation in order to detect the opening of a housing. For this purpose, a transmitter or a receiver of this radiation is proposed, which is arranged in a first housing. A complementary receiver or transmitter outside the first housing is assigned to this transmitter or receiver. As soon as the measured radiation changes due to a manipulation of the housing, this is detected.

A significant disadvantage of all these solutions is that separate attack detection circuits or data erasure circuits have to be provided. Drawbacks in this respect relate to retrofitting capability, production costs and security concerns, the latter especially when the computer system has been de-energized, e.g., for transportation purposes.

U.S. Pat. No. 6,233,339 appears to propose that to ensure the confidentiality of data even without the provision of attack detection circuits or data erasure circuits. It describes how to generate cryptographic keys on the basis of a fluid contained in a sealed container, said keys being contingent on the pressure existing in the container. In the event the container is opened, the respective key will be destroyed. This solution approach is also relatively sophisticated, and, what is more, experience has shown that fluids and electronic components do not at all harmonize with each other, so that strict separation is imperative.

US Patent Publication No. 2011/0099117 appears to describe the general principle of a physically unclonable function (PUF). Making use of a PUF pattern, the influence of an object shall be determined by an alteration of the PUF pattern. In particular, the improper handling or manipulation between the production site and the place of use of the object shall be determined by this.

U.S. Pat. No. 9,071,446 describes a method according to which such a PUF pattern is practically used. According to that approach, a chip, or a semi-conductor module, is protected by a PUF enclosure. This unique enclosure is produced during manufacture/fabrication and is irrevocably attached to the semi-conductor module. If this enclosure is manipulated with a view to gaining physical access to the chip, this can be detected by comparison with an initial measurement, and the chip can then render itself unusable. Such a PUF enclosure can only be produced and mounted in a costly and time-consuming way and by using the necessary equipment. What is more, the system cannot be restored after the PUF enclosure has been manipulated. For that reason, the method described in U.S. Pat. No. 9,071,446 is only suitable for small systems, such as individual computer chips, and is therefore unsuited for the retrofitting of existing systems.

### SUMMARY

Embodiments of the present invention provide a method and an apparatus for verifying the integrity of a physical space or dedicated environment and for implicitly protecting data that are stored on at least one electronic component. In particular, protection should be provided against unauthorized activities, for example, against spying on the behavior or content, as well as against manipulations or misappropriation through physical contact or physical nearness/proximity. It shall be feasible to implement the method and the apparatus more cost effectively and easier in new but also in existing computer systems (resp. their dedicated environments) and in particular dispense with the provision of an attack detection circuit or data erasure circuit. It is another objective of the invention to enable the protection system to be reinitialized (after maintenance). Moreover, for example, a 140-2 level 4 FIPS (Federal Information Processing Standard) certification of the computer system or a completely new 140-2 level 4 FIPS certification expanded to also embrace the dedicated environment is to be achieved in order to be able to operate the computer system in environments where no physical protection exists.

To achieve this, an embodiment of the present invention proposes based on a method of the kind first mentioned above, that: at least one transmitter for transmitting and at least one receiver for receiving electromagnetic signals are arranged in the dedicated physical environment, the characteristics of the transmission channel between transmitter and receiver, dependent on the dedicated physical environment and the components of the computer system, are measured, cryptographic material by means of which a second cryptographic key is generated is extracted from the measurement results of this measurement, and that this second cryptographic key is used for the additional encryption and decryption of the data and/or the first cryptographic key.

Embodiments of the present invention provide, on the basis of an apparatus of the kind first mentioned above, that an integrity measuring apparatus is arranged in the dedicated environment, said apparatus comprising at least a transmitting unit and a receiving unit and being capable of measuring the electromagnetic characteristics of the transmission channel between the transmitting unit and the receiving unit depending on the dedicated physical environment and the components of the computer system, and of extracting cryptographic material from the measurement results of this measurement.

These measures will cause the computer system and the stored data to be protected against unauthorized access. For this purpose, with the aid of the transmitter and the receiver a transmission channel extending through the physically dedicated environment is established for electromagnetic signals. This transmission channel has electromagnetic characteristics that are contingent on the properties of the physically dedicated environment, which in turn depend on the presence and distribution of the elements that form part of the computer system. Elements of this type are typically the processor unit, the storage medium and the housing equipped with cables, connectors, boards etc. The integrity measuring apparatus measures the electromagnetic characteristics of the transmission channel (amplitude and phase responses are recorded) between transmitter and receiver and extracts from the measured values of this measurement environment-dependent cryptographic key material from which a cryptographic key is generated which serves for the additional encryption and decryption of the data and/or the first cryptographic key.

In the event the physically dedicated environment changes, either as a result of the elements of the computer system being influenced or in case further elements are introduced/replaced by the attacker, the electromagnetic properties of the transmission channel also change, so that the cryptographic key material is destroyed and access to the data is no longer possible.

Embodiments of the present invention provide that before the electromagnetic properties of the transmission channel are measured, additional objects are positioned at sensitive positions (for example, at ventilation slots) but can also be randomly arranged in the physically dedicated environment. This increases the protection against manipulation even further. In this case, the sufficiently random arrangement of the objects serves to increase the quality of the key material and to virtually exclude a reproducibility of the electromagnetic properties (for example, the exploitation of natural resonances of the created cavities) of the transmission channel and thus the physical integrity of the environment. An unauthorized attacker can therefore extract neither the first nor the second cryptographic key. Said additional objects have an influence on the scattering behavior of the waves of the electromagnetic signals and in this way enable the minutest variations of the object shape and object position to be measured. For instance, the objects can be provided in the form of knotted wires/cables or electrostatically charged and crumpled metal foils which are attached to various items of the computer and housing parts and which deform when the housing is opened and as a result change irreversibly. Using different materials in this context is of particular advantage, with said materials looking the same on an X-ray image but having different electromagnetic properties. Expediently, materials having nonlinear properties can be put to use, as these, in case changes are detected, and can exert particularly strong effects. Moreover, environments exhibiting non-linearities can practically no longer be reproduced and systematized. For example, materials having a very high permeability can be used. These materials reduce the wavelengths so that even small variations of the environment, for example, drill holes, can be detected. However, materials with dielectric properties can also be employed. These will shift the resonance frequencies of occurring natural resonances.

Embodiments of the present invention provide for at least one of the transmitters and/or receivers to have a randomly positioned location in the physically dedicated environment. Also, in an embodiment, the position and design/configuration of the transmitters and receivers can even make it more difficult to reproduce the electromagnetic properties of the transmission channel. Especially, in an embodiment, the shape and mounting of the antennas can be used for this purpose.

Embodiments of the present invention provide for an additional selection or filtering of certain times and/or frequencies and/or spaces using transmit and/or receive filters (MIMO). This enables any interferences that may occur during normal operation of the computer system to be filtered out. For example, said interferences may be caused by a fan or rotating components of the hard disk drive of the computer system or can be influences the origin of which lies outside the dedicated environment. To enable such a filtering or selection to be carried out, it is frequently recommendable to provide further means. For instance, in the event several transmit and receive antennas are employed, space-time encodings and space-time filters can be used to eliminate or minimize the influence of certain interferences, with filter banks being available for this purpose, for example.

It is furthermore useful to verify the channel reciprocity between the transmitter and receiver. In order to measure and verify the channel reciprocity, it is advisable to connect transceivers to the antennas instead of individual transmitters and receivers. This enables an even better detection of potential disturbances and interferences, as well as attacks and manipulations. In particular, so-called relay attacks and man-in-the-middle attacks can be fended off.

In embodiments of the present invention, as a protection measure against potential electromagnetic incompatibility associated with the computer system, the integrity measurement is to be carried out prior to the computer product, housing, or system being put into fully operational use. For this purpose, a circuit can be provided, for example, that switches on the computer peripherals only after measurement of the transmission channels has been successfully completed.

It is considered particularly advantageous if the channel measurement takes place with authentic and replay-protected pilot signals. The pilot signals contain symbols which in turn are generated from data consisting of authentic cryptographic material protected against replay attacks (hash chains, HMAC (“hash-based message authentication code”), digital signatures, etc.). As a result of individual (per measuring signal) cryptographic material being coupled to each physical measuring signal, an attacker a priori does not know the relevant pilot signal and for that reason is unable to inject false authentic signals. In this context, techniques such as decision directed channel estimation can, for example, be implemented.

In embodiments of the present invention, it is of particular advantage if the antennas of the transmitters and/or receivers are made to form part of the integrity of the dedicated environment. For example, parts of the environment, e.g., housing parts, can be used as an antenna or part of the antenna. Likewise or alternatively, parts of the environment can exert deterministic, but at the same time difficult to predict (near-field) influences on the antenna, for example, frequency-selective detuning, changes in directional characteristics, etc.

Alternatively or additionally, it makes sense if the dedicated environment is measured at least once during the operation of the computer system, with the extracted material being used for integrity verification. The integrity verification during operation of the computer system can be made in addition to or as an alternative to the integrity check when the computer system is not yet in operation. The verification performed during the operation of the computer system attests to the integrity of the environment similar to known systems that are monitored by means of sensors. For example, a similarity measure between known and newly extracted material can be calculated to detect attempts at manipulation.

Another embodiment of the invention provides for the integrity verification of the dedicated environment to be initiated remotely via a secure communication interface. Depending on the requirements, several inventive systems can be checked at the same time via such an interface on a regular basis or for a given reason. It is of significance in this context to ensure secure communication with the computer system and/or the integrity measuring apparatus by adopting appropriate encryption techniques. Alternatively, a key can be extracted time and again in order to decrypt certain data or verify its authenticity.

Embodiments of the present invention ensure that the unique second cryptographic key can only be extracted from the transmission channel and thus from electromagnetic characteristics of the environment if their integrity has not been subject to changes. This makes it possible to effectively protect computer systems and the sensitive data stored on them against unauthorized activities. Particularly advantageous of the invention is the possibility of reinitialization, which means that after each authorized or unauthorized change to the environment or to the initial integrity, the system can again be measured and reinitialized provided the first cryptographic key is known.

### BRIEF DESCRIPTION OF THE DRAWINGS

Exemplary embodiments of the invention are illustrated by way of the following drawings.

FIG. 1 shows a representation of a conventional computer system as it is known from the state of the art.

FIG. 2 shows a representation of an apparatus embodiment of the present invention.

FIG. 3 shows schematically a method embodiment of the present invention.

FIG. 4 shows a representation of an apparatus embodiment of the present invention.

FIG. 5 shows schematically an example attempt to manipulate an apparatus embodiment of the present invention.

FIG. 6 shows a schematic representation of the measurement of a reciprocal transmission channel of the present invention.

FIG. 7 shows a representation of an apparatus embodiment of the present invention.

FIG. 8 shows a representation of an apparatus embodiment of the present invention.

### DETAILED DESCRIPTION

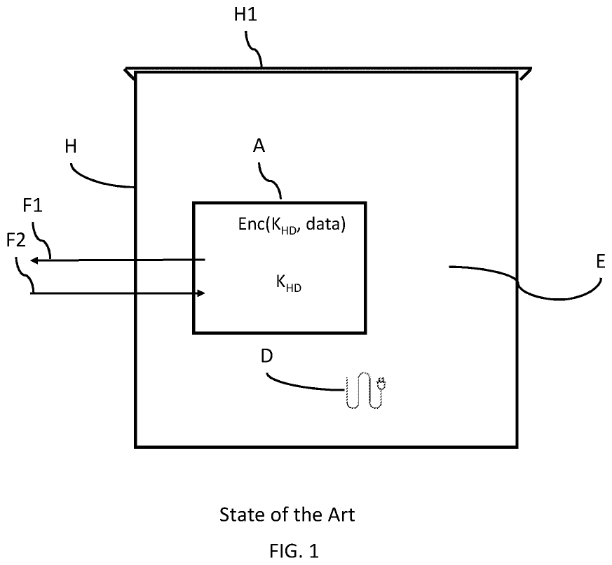

In FIG. 1 a computer system is illustrated identified with reference numeral A. The computer system A is assigned a dedicated environment which is defined by a housing H and more specifically by the housing interior E. The housing H is lockable by means of housing cover H1. The computer system can communicate with the outside environment (and be supplied with power) via inputs (F1) and outputs (F2).

The computer system A is equipped with a processor unit not shown here as well as a storage medium which has also not been shown in the figure. Sensitive data are stored on the storage medium, said data can be modified and read by the processor unit. The sensitive data are encrypted and/or integrity protected by means of a first cryptographic key K_{HD}. Moreover, the computer system A is equipped with additional hardware components D, which, for example, can comprise a power supply cable, a graphics card and/or a data cable.

An attacker can achieve access to computer system A by, for example, opening up the housing H through drilling or removing the housing cover H1, and in this way gains physical access to computer system A. The attacker will then be in a position to extract the first cryptographic key K_{HD} with the aid of physical approaches, reverse engineering and/or cryptoanalytical methods and as a result can decrypt, read or manipulate the sensitive data. Being in possession of the key, the attacker can also manipulate the data unnoticed.

The designation “Enc” in FIG. 1 stands for encryption, for example, in an authenticated encryption mode, or just a keyed-hashed message authentication code (HMAC).

The attacker may furthermore manipulate the entire computer system A in order to also gain future access to the data and the computer system A. Following this, the attacker can reclose the housing H and the manipulated computer system A continues to operate unnoticed.

Particularly in the area of ATMs (“automated teller machine”) or bank statement printers, such an attack causes major problems for ATM owners and operators today. More often than not, ATMs are equipped with cost-effective computer systems operating on obsolete software and hardware components with low security standards, which enables said ATMs to be easily manipulated. Such computer systems A process and store customer-specific data (for instance card number and PIN (“personal identification number”) as well as access to the cash dispenser or safe.

Another example in which the necessary safety level (for example, according to FIPS (“Federal Information Processing Standards”) 140 2 level 4) cannot be ensured with the assistance of state-of-the-art protection systems is the unprotected transport of the switched-off critical systems.

Therefore, the teachings of the invention embrace in particular the simple, cost-effective upgrade of such computer systems so that they meet the highest security standards, preferably “FIPS 140-2 level 4” (or comparable standards).

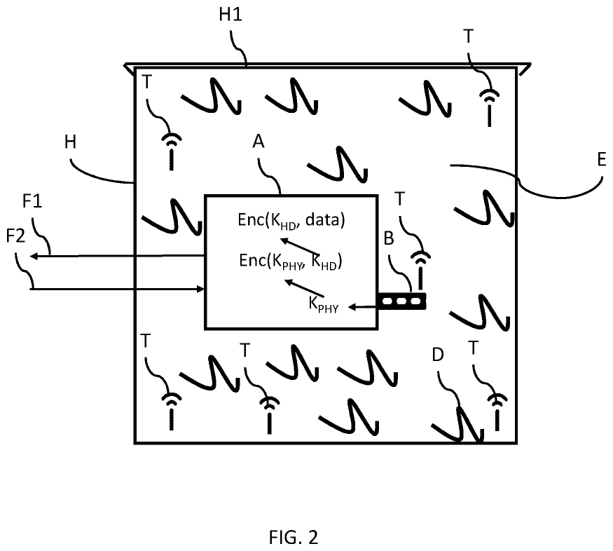

For this purpose and as has been shown in FIG. 2, an integrity measuring apparatus B with an antenna T is arranged in the housing H. Such an integrity measuring apparatus B can include, for example, of one or a plurality of software-defined-radio-plus-microcontrollers. As an alternative, an inexpensive off-the-shelf hardware with standard communication interfaces may also be considered. Hardware of this type is ideally the size of a cigarette box and comprises several transceivers. Additionally, several further antennas T and a plurality of objects D are randomly positioned in the housing H. The antennas T can be used as transmitting and/or receiving antennas. In this case, both the antennas T and the objects D are randomly arranged in the housing H. If considered suitable for a given application, the antennas T can also be positioned at random with some reservations (e.g., only at the outer edges). Depending on the relevant application, the housing itself can also serve as an antenna component. Objects D can, for example, include knotted cables/lines or metal foil which are attached at one end to the housing H and at the other end to the housing cover H1. Such randomly mounted objects D have the following characteristics: they are very easy to produce and install, but at the same time it is very difficult to reconstruct them conclusively. This also makes it extremely difficult to reconstruct the influence of objects D on the electromagnetic properties of the housing interior E and thus the integrity of the computer system A once said objects have been modified. In this way, it is very easy for an authorized technician to retrofit the hardware components (B, T, D) that are needed for the upgrade.

Computer system A can also be equipped with these hardware components (B,T,D) during the production/assembly process of new devices.

As soon as the additional hardware components (B,T,D) are installed and housing H is closed again, the authorized technician can put the computer system A into operation.

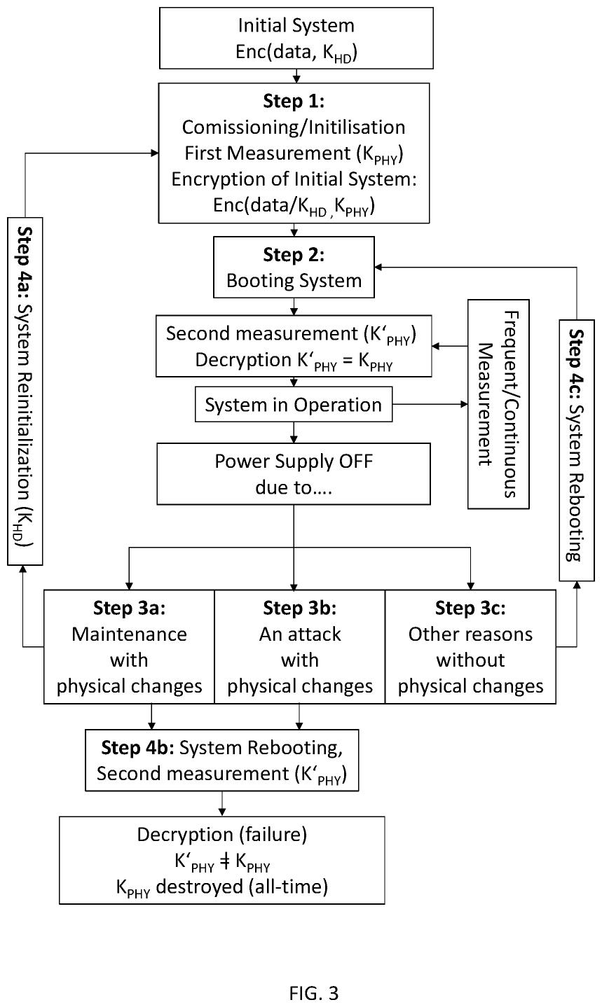

FIG. 3 is a flow chart of the method proposed by the invention. On the basis of an initial system, an authorized technician starts the system up as usual in a first step (Step 1). In addition, by entering the first cryptographic key K_{HD} and/or another cryptographic secret, the technician initiates the measurement of the electromagnetic characteristics of the housing interior E. The integrity measuring apparatus B extracts cryptographic material from the results of this measurement and by making use of this material subsequently generates a second cryptographic key K_{PHY}. The first cryptographic key K_{HD} is now stored encryptedly on the computer system A with the second cryptographic key K_{PHY}.

In a second step (step 2), the overall system (integrity measuring apparatus B and computer system A) is rebooted. For this purpose, the integrity measuring apparatus B takes a second measurement of the housing interior E. This takes place advantageously, but not necessarily, before the entire computer system A is booted so that interference with live and/or moving components, such as a hard disk drive, fan or the like is ruled out. From the measurement results of this second measurement, the integrity measuring apparatus B generates a third cryptographic key K′_{PHY}. In this case, the third cryptographic key K′_{PHY} corresponds to the second cryptographic key K_{PHY}, due to the fact that the electromagnetic characteristics of the housing interior E have not changed. As a result, the computer system A can decrypt the dataset that has been encrypted with the second cryptographic key K_{PHY} (consisting of the first cryptographic key K_{HD}) with the aid of the third cryptographic key K′_{PHY} so that the dataset can be accessed in the usual manner. The second step (Step 2) can be performed automatically after the first step has been initiated by the authorized technician.

Now, the computer system A is in operation and can perform the relevant tasks assigned to it. To suit individual requirements, measurements of the housing interior E can be carried out during operation on a regular or continuous basis. In this manner, the integrity of the housing interior E is continuously verified with the dataset being decrypted, for example, each time a new operating cycle is performed, with the help of a third cryptographic key K′_{PHY} generated in each case. The integrity measuring apparatus B in this case functions like known sensor systems, such as optical or capacitive systems.

In a third step (Step 3a, Step 3b, Step 3c), the entire system is disconnected from the power supply and is in de-energized state.

This can occur, for example, as a result of maintenance work (step 3a). During maintenance work, the integrity of the housing interior is changed. This can be caused by the housing being opened as well as the modification/replacement of hardware elements of computer system A, in particular by changing the position of the objects D and the antennas T, which are randomly arranged in the housing interior E. Alone the skillful positioning and suitable material selection of the objects D and antennas T in the housing interior E will result in the housing integrity to be no longer restorable.

However, the system could also be maliciously disconnected from the power supply by an attacker (Step 3b). After the attackers have de-energized the system, they can gain physical access to computer system A in a variety of ways. But even in such a case the attacker will also unintentionally change the integrity of the housing interior E, especially if the objects D and antennas T are skillfully positioned and appropriate materials have been selected.

In both cases (Step 3a, Step 3b), simply rebooting the system (Step 4b) would lead to a remeasurement of the housing interior E analogous to the second step (Step 2). Based on the results of this remeasurement, the integrity measuring apparatus B again generates a third cryptographic key K′_{PHY}. However, such a third cryptographic key K′_{PHY} will no longer be identical to the second cryptographic key K_{PHY}, because the integrity of the housing interior E has changed and with it the electromagnetic characteristics of the transmission channel or channels. Accordingly, the cryptographic material which is used and required for the generation of the second cryptographic key K_{PHY} can no longer be extracted. Rather, other cryptographic material is extracted and therefore a third cryptographic key K′_{PHY} is generated which does not correspond to the second cryptographic key K_{PHY}. Any attempt to decrypt the dataset on the computer system by means of the newly generated third cryptographic key K′_{PHY} will fail. Due to the change of the integrity of the housing interior E, the second cryptographic key K_{PHY} can no longer be restored or reconstructed.

Nevertheless, other than the malicious attacker, the authorized technician knows the first cryptographic key K_{HD} and/or another cryptographic secret. Based on this knowledge, the authorized technician can reinitialize the system (step 4a) resulting in a new second cryptographic key K_{PHY} being generated (step 1) on the basis of the new electromagnetic characteristics of the transmission channel with the system then being put into the operational state as described.

However, the system can also be de-energized due to other external circumstances, such as a power failure or carelessness on the part of personnel (Step 3c). In such a case the system can simply be rebooted (Step 4c). The integrity of the housing interior has not changed, so that the system can be returned to its normal operating state as described starting with the second step (Step 2).

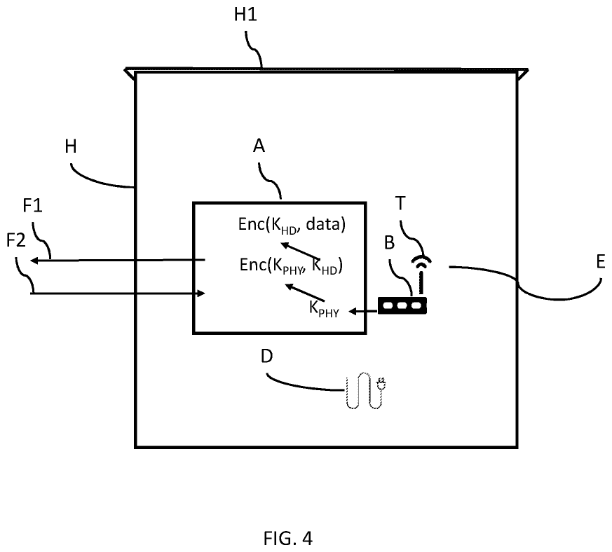

FIG. 4 shows a basic version of the integrity measuring apparatus B which in this case is being equipped with an antenna T. In principle, any antenna T can be operated as a transmitting antenna, receiving antenna or as a transmitting/receiving antenna. The antenna T illustrated in FIG. 4 is designed as a transmit/receive antenna. The integrity measuring apparatus B has a full duplex function in order to minimize self-interference at the single antenna T. In this embodiment example, only the hardware of the computer system A, the hardware of the integrity measuring apparatus B as well as the housing H and the housing cover H1 have an influence on the electromagnetic characteristics of the housing interior E. Even these system-specific components are often sufficient to change the electromagnetic properties existing within the housing interior E both during authorized and also unauthorized access in such a way that the extracted cryptographic material is destroyed so that, consequently, the second and the third cryptographic key K_{PHY}, K′_{PHY} can no longer be reconstructed.

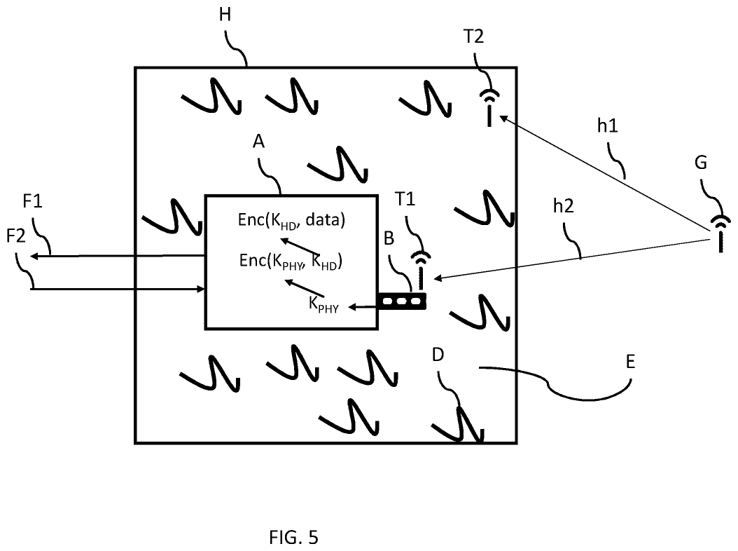

FIG. 5 schematically shows the malicious attack on an inventive computer system A during the measurement of the electromagnetic characteristics of the transmission channel between antenna T1 and T2. An attacker G now manipulates the one-sided transmission channel measurement or the environmental measurement from antenna T1 to antenna T2 by exerting strong (artificial or natural) interferences in order to change significant components of the cryptographic material extracted from the characteristics of the transmission channel. During an unauthorized access to computer system A this manipulation can now be reproduced with a view to decrypting in this way the first cryptographic key K_{HD} despite the violation of the physical integrity.

It is also conceivable that the attacker G successfully performs relay attacks between the legitimate sender and receiver to influence the key material.

The two described attacks can be defended against/detected by making use of the channel reciprocity, because the transmission channel between antenna T1 and antenna T2 is conjugate complex reciprocal/symmetric and because it is not possible for an attacker to exactly predict or calculate the environment in order to generate special interferences with this information, which at both antennas T1 and T2 cause the transmission channel in between to appear as symmetric/reciprocal. For this purpose, the antennas T1, T2 are connected to transceivers and can therefore operate as transmit and receive antennas.

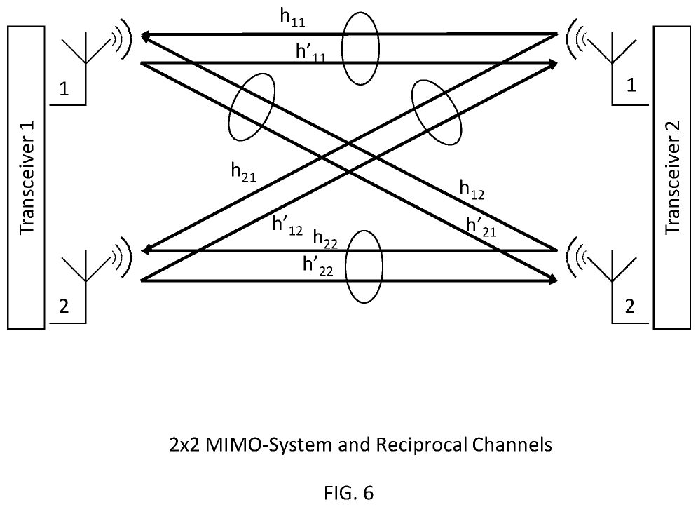

In FIG. 6, an example of a 2×2 antenna setup is illustrated for verifying the reciprocity of the respective transmission channels. If the physical environment has not changed during the measurements, the bidirectional/pairwise measurements between two antennas T1, T2 are reciprocal due to physical properties (conjugate complex symmetric).

With a view to extracting secret information from these transmission channels, both the channel profiles (or their statistics) themselves and/or characteristics existing between these profiles/statistics can be used. Characteristics between these profiles/statistics are, for example, the (Pearson) correlation, Euclidean distance, transinformation etc. of different channel profiles, for example, between h₁₁ and h₁₂ or between h₁₁ and h₂₁ etc. (cf. FIG. 6).

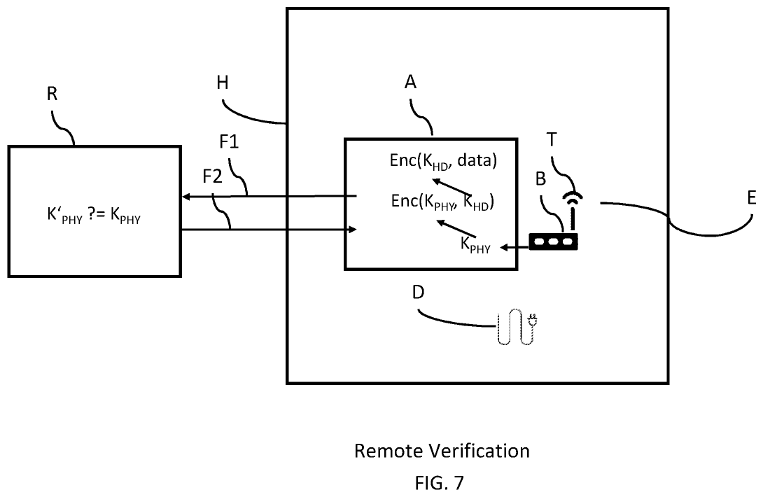

FIG. 7 shows another embodiment example of an apparatus proposed by the invention. Other than provided for in FIGS. 2 and 4, the integrity verification is not initiated locally by computer system A and/or the integrity measuring apparatus B, but by means of a remotely connected computer system R. The remotely connected computer system R must first establish a secure connection with the local computer system A so that the communication between the two computer systems A,R cannot be manipulated.

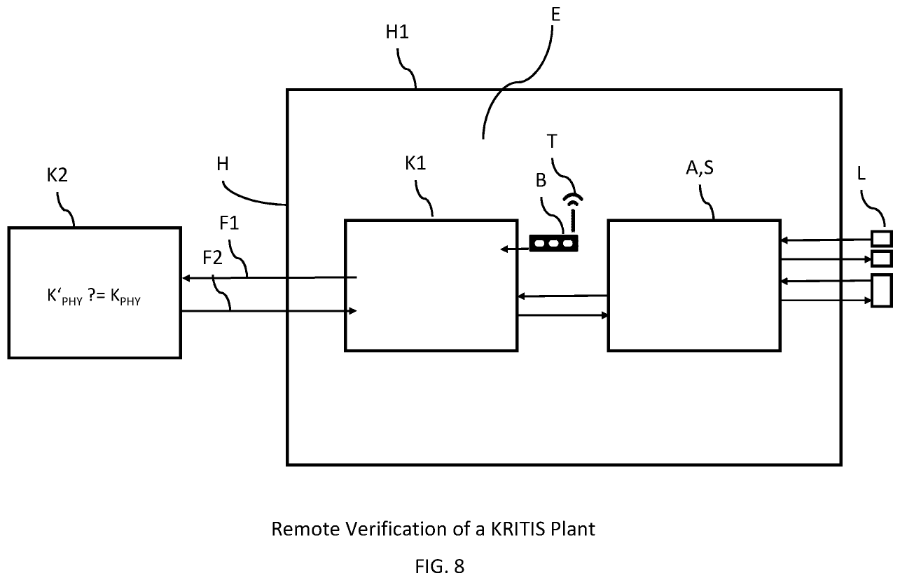

In FIG. 8, an embodiment example of an inventive apparatus is illustrated in the operating environment of an industrial plant. In this configuration, for example, the computer system A is represented by a control system in the form of a programmable logic controller (PLC) S. This programmable logic controller S is connected to a multitude of actuators and sensors L in the field and controls them as prescribed by its programming necessities. In addition, it is capable of transmitting data received from the sensors or a control protocol to a higher-ranking system K2, for which purpose a communication module K1 is provided. Said module K1 can, for example, be an industrial gateway or a router. In this case, the higher-ranking system K2 can also initiate the integrity check remotely, analogously to what has been indicated in FIG. 7.

This embodiment example is in particular suitable for the protection of critical infrastructures (cf. EU Directive 2008/114/EG). Infrastructures of this nature require the integrity to be monitored on a regular or even constant basis. Considering the ever-increasing networking capabilities of these infrastructures (e.g., SmartGrid, SmartHome and SmartPowerGeneration), manipulations of individual infrastructures can quickly scale up to other structures of the same type or to higher or lower ranking structures, so that a major standstill/failure of the entire system can follow (for instance, due to a blackout) doubtlessly causing substantial damage.

Throughout the above and the Figures, various representative symbols are used including the following:
A Computer system;
B Integrity measuring apparatus;
T Antenna;
T1 Transceiver antenna;
T2 Transceiver antenna;
D Objects;
H Computer housing;
E Housing interior (physically dedicated environment);
F1 Power/data inputs;
F2 Power/data outputs;
G Attacker;
h_{xy} Transmission channel between transmitter X and receiver Y;
R Remotely connected computer system;
K Communication module;
S Control system/Programmable logic controller (PLC); and
L Sensors, actuators, field components.

1-16. (canceled)

17. A method for protecting data of a computer system against unauthorized activities, in which data of the computer system which are stored on a storage medium and encrypted and/or integrity-protected with a first cryptographic key can be changed by means of a processor unit of the computer system which is connected to the storage medium and both the storage medium and the processor unit are arranged in a physically dedicated environment, comprising:
arranging at least one transmitter for transmitting and at least one receiver for receiving electromagnetic signals in the physically dedicated environment,
measuring at least one characteristic of the transmission channel between transmitter and receiver that are dependent on the dedicated physical environment and the components of the computer system,
extracting cryptographic material, from which a second cryptographic key is generated, from the measurement results of this measurement, and
using the second key for additional encryption and decryption of the data and/or the first cryptographic key.

18. The method of claim 17, further comprising, upon access to the dedicated environment, changing the electromagnetic characteristics of the transmission channel, such changing causing the cryptographic material and the second cryptographic key to be destroyed.

19. The method of claim 17, further comprising, that before the measurement of the electromagnetic characteristics of the transmission channel takes place, objects are additionally randomly positioned locally in the physically dedicated environment.

20. The method of claim 17, further comprising randomly positioning at least one of the transmitters and receivers in the physically dedicated environment.

21. The method of claim 17, further comprising carrying out at least one of a selection and filtering of certain times and/or frequencies and/or spaces.

22. The method of claim 17, further comprising verifying channel reciprocity between transmitter and receiver.

23. The method of claim 17, further comprising measuring the integrity of the dedicated environment before carrying out a commissioning of the computer system.

24. The method of claim 17, wherein the measuring of the transmission channel takes place using authentic and replay-protected pilot signals.

25. The method of claim 17, wherein the antennas of the transmitters and/or receivers form part of the integrity of the dedicated environment.

26. The method of claim 17, wherein the dedicated environment is measured at least once during the operation of the computer system and the extracted material is used for integrity verification of the dedicated environment.

27. The method of claim 25, wherein the integrity verification of the dedicated environment is initiated remotely via a secure communication interface.

28. An apparatus for the protection of data against unauthorized activities,
in which data of a computer system which is stored on a storage medium and encrypted with a cryptographic key and/or integrity-protected can be changed by means of a processor unit connected to the storage medium and both the storage medium and the processor unit are arranged in a physically dedicated environment, comprising:
an integrity measuring apparatus arranged in the dedicated environment, said apparatus having at least one transmitting unit and one receiving unit and being suitable for measuring the electromagnetic characteristics of the transmission channel between the transmitting unit and the receiving unit, said characteristics being dependent on the dedicated physical environment and the components of the computer system, and for extracting cryptographic material from the measurement results of this measurement.

29. The apparatus of claim 27, characterized in that additionally arranged objects (D) are randomly positioned locally in the dedicated environment.

30. The apparatus of claim of claim 28, further comprising means for the selection or filtration of certain frequencies being additionally provided.

31. The apparatus of claim 28, wherein transmitting and receiving units are designed as transceivers.

32. The apparatus of claim 28, wherein that means are provided for measuring the integrity of the dedicated environment before the computer system is put into operation.
